(19) United States
(12) Patent Application Publication
(10) Pub. No.: US 2026/0359014 A1
(43) Pub. Date: Nov. 12, 2026

(54) METHOD FOR GENERATING AN APPLICATION FOR PROCESSING AT LEAST ONE MULTIMEDIA STREAM, AND ASSOCIATED DEVICE AND COMPUTER PROGRAM

(71) Applicant: Orange, Issy-Les-Moulineaux (FR)

(72) Inventors: Olivier HOTEL, Chatillon Cedex (FR); Franck ROUDET, Chatillon Cedex (FR); David EXCOFFIER, Chatillon Cedex (FR)

(21) Appl. No.: 19/136,199

(22) PCT Filed: Dec. 4, 2023
(86) PCT No.: PCT/EP2023/084177

§ 371 Date: Jun. 5, 2025

(30) Foreign Application Priority Data
Dec. 9, 2022 (FR) FR2213083

(51) Int. Cl. G06F 8/30

(52) U.S. Cl. CPC G06F 8/30

(57) ABSTRACT

A solution for generating an application for processing a multimedia stream including an assembly of elementary processing functions, these elementary processing functions being instantiated on compute nodes. A configuration file is provided to each elementary processing function in order to realise this assembly. Thus, such a method makes it possible to benefit from the advantages of “low code” or “no code” techniques, while offering the possibility of selecting elementary functions instantiated on suitable compute nodes.

### CROSS-REFERENCE TO RELATED APPLICATIONS

This application is filed under 35 U.S.C. § 371 as the U.S. National Phase of Application No. PCT/EP2023/084177 entitled “METHOD FOR GENERATING AN APPLICATION FOR PROCESSING AT LEAST ONE MULTIMEDIA STREAM, AND ASSOCIATED DEVICE AND COMPUTER PROGRAM” and filed Dec. 4, 2023, and which claims priority to FR2213083 filed Dec. 9, 2022, each of which is incorporated by reference in its entirety.

### BACKGROUND

### Field

The field of the development is that of computer vision applications, the purpose of which is to process multimedia streams. More specifically, the development relates to computer vision applications assembled in a graphical or “low code” manner.

### Description of the Related Technology

Classically, computer vision applications are based on a computer code written by computer language specialists. These codes are used to call up functions, that are also coded, applying one or more processing operations to images constituting the multimedia stream to be processed.

However, such applications lack modularity, because they are coded in a monolithic manner, called functions being integrated into the application code itself. Thus, any change made to one of these functions may require the application code to be rewritten in whole or in part.

With the development of digital technologies, the need for application development has increased. To meet this growing need, techniques for generating applications that require little or no computer coding skills have been developed. Such techniques are known as “low code” or “no code”.

Such techniques consist in writing computer code corresponding to elementary processing functions. Thus, each elementary processing function corresponds to a functional block, for example a “facial recognition” block, an “image resizing” block, etc.

Someone wishing to generate a specific application, such as a computer vision application, selects several functional blocks belonging to a library of elementary processing functions made available to them, and assembles them in an orderly manner to generate the application enabling the desired processing operation to be obtained.

As the various elementary processing functions are developed independently of each other, a change impacting one of them has no effect on the other elementary processing functions constituting the application, which reduces the need to rewrite the application code.

One disadvantage of these solutions is that the various functional blocks offered by a “low code” or “no code” application generation service provider are instantiated on the same compute node. However, depending on the processing operations performed by the various functional blocks on the images constituting the multimedia stream, the compute node on which these functional blocks are instantiated may not have the resources needed to execute correctly certain elementary processing functions. In such a case, the computer vision application does not provide a satisfactory quality of service.

There is therefore a need for a technique for generating an application for processing a multimedia stream that does not have some or all of the above-mentioned disadvantages.

### SUMMARY

The development meets this need by proposing a method for generating an application for processing at least one multimedia stream, said processing application comprising an assembly of elementary processing functions.

Such a method is particular in that it is implemented by a module for generating applications comprising the following steps of:
selecting elementary processing functions intended to be assembled to generate said processing application, an elementary processing function being instantiated on a compute node executing said elementary processing function,
for a given selected elementary processing function, associating a configuration file comprising at least one parameter relating to at least a first elementary processing function generating data intended to be processed by said given elementary processing function.

Such a solution is cleverly based on providing, in a configuration file, parameters allowing a given elementary processing function to identify one or more other elementary processing functions from which to obtain data to be processed.

Providing these parameters makes it possible to instantiate these elementary processing functions on distinct compute nodes. Each elementary processing function can be instantiated on a compute node having the resources that meet its needs. In the remainder of the document, a compute node is defined as any piece of equipment or device having the resources needed to execute an elementary processing function. Thus, a compute node may be a camera, a display device such as a screen or a smartphone, a virtual machine, a compute node of a Kubernetes node cluster, a server, a personal computer, a CPU (Central Processing Unit), a GPU (Graphical Processing Unit), etc.

Such a configuration file can be generated automatically by the generation module, for example when the parameters relating to an elementary processing function are associated with the latter in the functional block library. Thus, the simple selection of the elementary processing functions to be assembled triggers the generation of the corresponding configuration files.

The configuration file can also be generated by a user of the generation module for each elementary processing function. Such an implementation allows greater flexibility in the scheduling of the elementary processing functions between them, since the user can choose the inputs for a given elementary processing function, rather than being constrained by the information provided by the functional block library.

Thus, such a method makes it possible to benefit from the advantages of “low code” or “no code” techniques, while offering the possibility of selecting elementary functions instantiated on suitable compute nodes. Such a method also enables the elementary processing functions to be pooled between several distinct multimedia stream processing applications.

The parameter relating to said first elementary processing function provided by the configuration file comprises, among others:
a network address of said compute node on which said first elementary processing function is instantiated,
a port of said compute node on which said first elementary processing function is instantiated through which the data generated by said first elementary processing function is intended to be provided,
an identifier of said first elementary processing function.

Such information enables the given elementary processing function to identify the compute node concerned and to collect the appropriate data from the latter.

This information can also easily be identified and understood by a user, who can then enter it themselves with ease to a configuration file.

More particularly, the parameter relating to said first elementary processing function constitutes an argument of said given selected elementary processing function.

The configuration file further comprises, for said given selected elementary processing function:
an identifier of at least one module for providing said data generated by said given selected elementary processing function.

Such a providing module belongs to the group further comprising:
a port of said compute node on which said given selected elementary processing function is instantiated,
a module for displaying said multimedia stream,
a memory.

Depending on the position of the given elementary processing function in the assembly of elementary processing functions constituting the application, the data generated by its execution is intended either to be provided as input to another elementary processing function that will apply an additional processing operation to it, or to be provided to display and/or storage modules. Such display and/or storage modules can be embedded in the compute node.

The development also relates to a method for processing at least one multimedia stream by a processing application comprising an assembly of elementary processing functions, an elementary processing function being instantiated on a compute node executing said elementary processing function.

Such a processing method is particular in that it is implemented by a compute node and it comprises a step of:
obtaining data contained in said multimedia stream to be processed,
processing, by said elementary processing function instantiated on said node, said obtained data,
generating metadata associated with said processed data,
providing said processed data and said generated metadata.

More particularly, the data obtained is provided by at least one elementary processing function identified in a configuration file of said elementary processing function instantiated on said node.

Indeed, as explained above, the various elementary processing functions constituting the application are provided with a configuration file comprising the information thanks to which a given elementary processing function can identify the compute node from which to collect the data it must process. This information being arguments of the given elementary processing function is provided to it when the application is generated. Thus, from the first execution of the application, each elementary processing function is able to collect the data it must process.

In some cases, the data obtained is acquired by the compute node itself.

This is the case, for example, when the compute node is embedded in a camera that captures a scene.

The data obtained can be accompanied by metadata that is associated with it, said metadata having also been generated by the elementary processing function identified in the configuration file of said elementary processing function instantiated on said node.

This metadata can contain information relating to the processing operation previously performed on the images of the multimedia stream.

Similarly, the metadata generated by said elementary processing function instantiated on said node belongs to the group further comprising:
coordinates of a camera having acquired the content of the multimedia stream,
an identifier of said camera,
coordinates of at least one motion vector calculated for at least one image constituting the multimedia stream,
at least one identifier of at least one object detected in at least one image constituting the multimedia stream.

This metadata is comprised in a data field of said at least one stream, relating to at least one still image to be processed.

For example, the metadata is comprised in an AAPn or COM field of the JPEG format, or in one of the iTXt, tEXt and zTXt fields of the PNG format.

Thus, it is not necessary to generate new messages to transmit this additional data. This makes it easier to implement the present development in existing systems.

The development also relates to a module for generating an application for processing at least one multimedia stream, said processing application comprising an assembly of elementary processing functions.

Such a module for generating applications comprises means for:
selecting elementary processing functions intended to be assembled to generate said processing application, an elementary processing function being instantiated on a compute node executing said elementary processing function,
for a given selected elementary processing function, associating a configuration file comprising at least one parameter relating to at least a first elementary processing function generating data intended to be processed by said given elementary processing function.

The development also relates to a compute node on which at least one elementary processing function comprised in an application for processing a multimedia stream is instantiated.

Such a compute node executes said elementary function and comprises at least one processor configured to:
obtain data contained in said multimedia stream to be processed,
process, by means of said elementary processing function instantiated on said node, said obtained data,
generate metadata associated with said processed data,
provide said processed data and said generated metadata.

Finally, the development relates to computer program products comprising program code instructions for implementing the methods as described previously, when they are executed by a processor.

The development also relates to a computer-readable storage medium on which are saved computer programs comprising program code instructions for implementing the steps of the methods according to the development as described above.

Such a storage medium can be any entity or device able to store the programs. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer programs contained therein can be executed remotely. The programs according to the development can be downloaded in particular on a network, for example the Internet network.

Alternatively, the storage medium can be an integrated circuit in which the programs are embedded, the circuit being adapted to execute or to be used in the execution of the above-mentioned methods that are the subject of the development.

### BRIEF DESCRIPTION OF THE DRAWINGS

Other purposes, features and advantages of the development will become more apparent upon reading the following description, hereby given to serve as an illustrative and non-restrictive example, in relation to the figures, among which:

FIG. 1: this figure shows a system in which the present development is implemented,

FIG. 2: this figure shows the various steps implemented to generate an application for processing a multimedia stream,

FIG. 3: this figure shows a first example of the assembly of elementary processing functions,

FIG. 4: this figure shows a second example of the assembly of elementary processing functions,

FIG. 5: this figure shows the various steps implemented to process a multimedia stream by means of a processing application shown in FIG. 3 and obtained according to the method described with reference to FIG. 2,

FIG. 6: this figure shows a generation module according to one embodiment of the development. A generation module is able to implement the method for generating an application for processing a multimedia stream according to FIG. 2.

### DETAILED DESCRIPTION OF CERTAIN ILLUSTRATIVE EMBODIMENTS

The general principle of the development is based on the generation of an application for processing a multimedia stream comprising an assembly of elementary processing functions, these elementary processing functions being instantiated on compute nodes. A configuration file is provided to each elementary processing function in order to realise this assembly.

Thus, such a method makes it possible to benefit from the advantages of “low code” or “no code” techniques, while offering the possibility of selecting elementary functions instantiated on suitable compute nodes.

In relation to FIG. 1, a system in which the present solution is implemented is now presented.

Such a system is a distributed system in which a plurality of compute nodes communicate with each other to process a multimedia stream.

The system thus shown comprises, for example, a module for generating 10 an application for processing a multimedia stream. Such a generation module 10 is, for example, embedded in a server or in a virtual machine operated by a multimedia stream processing service provider.

Such a generation module 10 comprises a library 12 of elementary processing functions FTE, or functional blocks. Such elementary processing functions FTE are, for example, a function for acquiring images representative of a scene, a function for resizing an image, a colorimetry function, an object detection function, a function for displaying multimedia content or for storing multimedia content, etc. Each of these elementary processing functions FTE is instantiated on a compute node 11-i having the resources needed to execute the instantiated elementary processing function FTE. A single compute node can instantiate several elementary processing functions FTE. By way of example, a compute node can be any piece of equipment or device having the resources needed to execute an elementary processing function. Thus, a compute node can be a camera, a display device such as a screen or a smartphone, a virtual machine, a compute node of a Kubernetes node cluster, a server, a personal computer, a CPU, a GPU, etc.

Although four compute nodes 11-1 to 11-4 are shown in FIG. 1, the number of compute nodes involved in implementing the present solution depends on the number of elementary processing functions FTE assembled to constitute the application for processing a multimedia stream.

In the present solution, three types of elementary processing functions FTE are considered. A first type of elementary processing functions is called source FTES, a second type is called operation FTEO and a third type is called sink FTEP.

A source function FTES is an elementary processing function having no input but at least one output.

When an elementary processing function has no input, this means that the data it processes is not supplied to it by another elementary processing function, but that it obtains it by another means. A source function FTES is, for example, a function for decoding images acquired by a camera or a demosaicing function. A source function FTES can also read the data it must process from a memory.

An output of an elementary processing function is, for example, a port of the compute node 11-i on which it is instantiated and via which the data generated by the elementary processing function is provided (or made accessible).

An operation function FTEO is an intermediate processing function having one or more inputs and one or more outputs. Such an operation function FTEO obtains data to be processed on each of its inputs from an output of another source or operation elementary processing function FTE and makes the data it has generated accessible on each of its outputs.

Finally, a sink function FTEP is an elementary processing function having no output but at least one input.

When an elementary processing function has no output, this means that the data it has processed is not provided to another elementary processing function, but that it is presented to an end user. A sink function FTEP is, for example, a display device or a data storage module.

An application for processing a multimedia stream is an assembly of at least one source function FTES and at least one sink function FTEP. Such an application can also comprise at least one operation function FTEO.

FIG. 2 shows the various steps implemented to generate an application for processing a multimedia stream.

In a step E1, the generation module 10 selects, from the library 12, at least one source function FTES, in the example described this is the “Camera” source function, at least one operation function FTEO, in the example described two operation functions are selected: a first “Resize” operation function that resizes the images and a second “YOLO” (You Only Look Once) operation function that detects objects in an image, and at least one sink function FTEP “Viz” that displays the results of the various processing operations performed on a screen. Of course, other elementary processing functions can be selected and assembled in order to generate an application for processing a multimedia stream.

An end user can interact with the generation module 10 by means of a human-machine interface (not shown in the figures) such as a touch screen or a screen-keyboard pair in order to transmit to the generation module 10 instructions for selecting the various elementary functions FTE to be assembled.

Once the various elementary processing functions FTE have been selected, they are assembled in order to generate the application for processing a multimedia stream.

To do this, a configuration file FC is provided to each of the selected elementary processing functions FTE.

Such a configuration file FC is generated during a step E2. In a first embodiment, a configuration file FC can be generated automatically by the generation module 10, for example when the parameters relating to an elementary processing function are associated with the latter in the library 12. Thus, the selection of the elementary processing functions FTE to be assembled and the scheduling between them trigger the generation of the corresponding configuration file(s).

In a second embodiment, the configuration file FC can also be generated by the user of the generation module 10. Such an implementation allows greater flexibility in the scheduling of the elementary processing functions between them, since the user can choose the inputs for a given elementary processing function, rather than being constrained by the information provided by the library 12.

For a source function FTES, such a configuration file FC comprises at least one identifier of at least one output or providing module on which the data processed or generated by the source function FTES is intended to be made accessible.

Such an identifier is, for example, a port/path pair, where “port” corresponds to a port number of the compute node on which the function FTE is instantiated and “path” is a parameter identifying the elementary processing function FTE that made the data accessible. The “port” parameter is particularly useful when a single compute node instantiates several elementary processing functions FTE.

For an operation function FTEO, such a configuration file FC comprises at least one identifier of at least one input or at least one identifier of at least one output on which the data processed or generated by the operation function FTEO is intended to be provided.

More particularly, such a configuration file FC comprises for each input of the operation function FTEO a network address of a compute node on which at least one source function FTS and/or at least one other operation function are instantiated, these elementary processing functions providing data to be processed to the operation function FTEO, a port of the compute nodes concerned on which these source functions FTES and/or these operation functions FTEO provide the generated data and an identifier of these source functions FTES and/or of these operation functions FTEO.

The configuration file FC also comprises at least one identifier of at least one output on which the data processed or generated by the operation function FTEO is intended to be provided.

Finally, for a sink function FTEP, such a configuration file FC comprises for each input of the sink function FTEP a network address of a compute node on which at least one source function FTS and/or at least one operation function are instantiated, these elementary processing functions providing data to be processed to the sink function FTEP, a port of the compute nodes concerned on which these source functions FTES and/or these operation functions FTEO provide the generated data and an identifier of these source functions FTES and/or of these operation functions FTEO.

Once the configuration files have been generated, the latter are transmitted in a step E3 to the various selected elementary processing functions FTE.

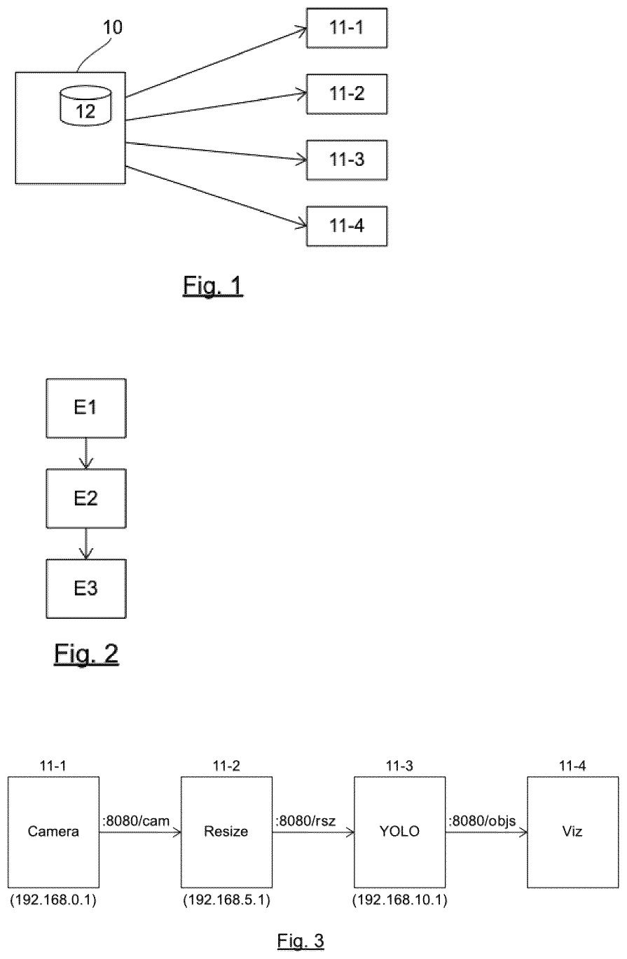

FIG. 3 shows a first example of the assembly of elementary processing functions FTE. Such an assembly comprises a “Camera” source function FTES configured to decode the images acquired by a camera. This source function has a single output. Such a source function is for example instantiated on a CPU compute node 11-1.

The assembly then comprises a first “Resize” operation function that resizes the images acquired by the camera. The “Resize” function has one input that collects the data provided by the “Camera” function and a single output. Such an operation function is for example instantiated on a CPU compute node 11-2.

The assembly comprises a second “YOLO” operation function that detects and identifies the objects present in the images acquired by the camera. The “YOLO” function has a single input that collects the data provided by the “Resize” function and a single output. Such an operation function is for example instantiated on a GPU compute node 11-3.

Finally, the assembly comprises a sink function FTEP “Viz” that displays the images acquired by the camera on a screen. The “Viz” function has a single input that collects the data provided by the “YOLO” function and does not comprise any output. Such a sink function is for example instantiated on a CPU compute node 11-4.

With reference to the assembly described in FIG. 3, the configuration file FC1 of the “Camera” function comprises the following data:
/Camera -port=8080,
   where /Camera is the identifier of the source function, and -port=8080 is the identifier of the providing module on which the data processed by the sink function is made accessible.

The configuration file FC2 of the “Resize” function comprises the following data:
/Resize 192.168.0.1: 8080/cam -port=8080,
   where /Resize is the identifier of the first operation function, 192.168.0.1 is the network address of the compute node 11-1 on which the “Camera” function is instantiated and 8080/cam is the port/path pair of the compute node on which the “Camera” function is instantiated and on which the data processed by the “Camera” function is provided, and -port=8080 is the identifier of the providing module on which the data processed by the “Resize” function is made accessible.

The configuration file FC3 of the “YOLO” function comprises the following data:
/YOLO 192.168.5.1: 8080/rsz -port=8080,
   where /YOLO is the identifier of the second operation function, 192.168.5.1 is the network address of the compute node 11-2 on which the “Resize” function is instantiated and 8080/rsz is the port/path pair of the compute node on which the “Resize” function is instantiated and on which the data processed by the “Resize” function is provided, and -port=8080 is the identifier of the providing module on which the data processed by the “YOLO” function is made accessible.

Finally, the configuration file FC4 of the “Viz” function comprises the following data:
/Viz 192.168.10.1: 8080/objs,
   where /Viz is the identifier of the second sink function, 192.168.10.1 is the network address of the compute node 11-3 on which the “YOLO” function is instantiated and 8080/objs is the port/path pair of the compute node on which the “YOLO” function is instantiated and on which the data processed by the “YOLO” function is provided.

Once it has its configuration file FC, each elementary processing function FTE knows from which compute node to obtain the data it must process and on which access module it must make its own data accessible.

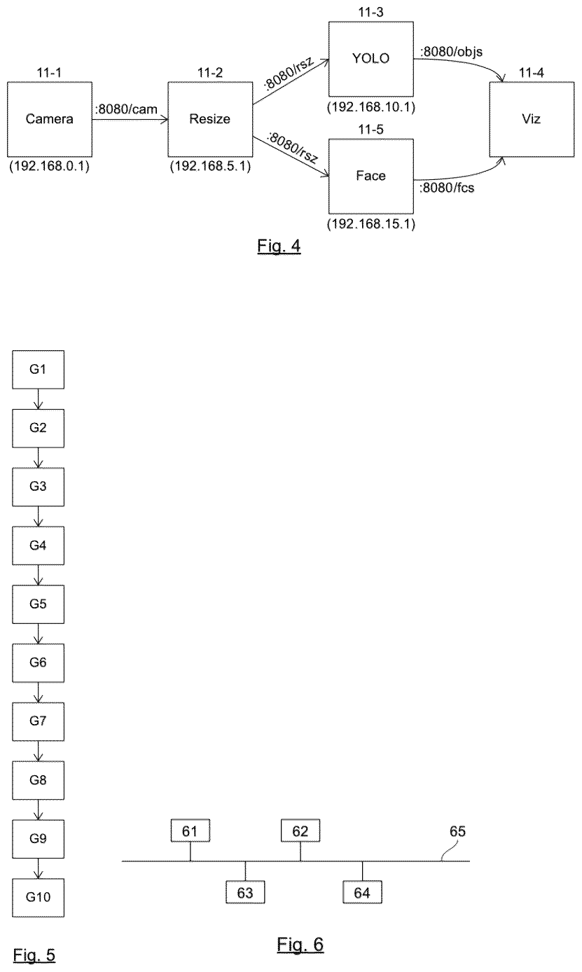

FIG. 4 shows a second example of the assembly of elementary processing functions FTE. Such an assembly comprises a “Camera” source function FTES configured to decode the images acquired by a camera. This source function has a single output. Such a source function is for example instantiated on a CPU compute node 11-1.

The assembly then comprises a first “Resize” operation function that resizes the images acquired by the camera. The “Resize” function has one input that collects the data provided by the “Camera” function and two outputs. Such an operation function is for example instantiated on a CPU compute node 11-2.

The assembly comprises a second “YOLO” operation function that detects and identifies the objects present in the images acquired by the camera. The “YOLO” function has a single input that collects the data provided by the “Resize” function and a single output. Such an operation function is for example instantiated on a GPU compute node 11-3.

The assembly comprises a third operation function “Face” that detects for example the faces present in the images acquired by the camera. The “Face” function has a single input that collects the data provided by the “Resize” function and a single output. Such an operation function is for example instantiated on a GPU compute node 11-5.

Finally, the assembly comprises a sink function FTEP “Viz” that displays the images acquired by the camera on a screen. The “Viz” function has two inputs, a first input that collects the data provided by the “YOLO” function and a second input that collects the data provided by the “Face” function and contains no output. Such a sink function is for example instantiated on a CPU compute node 11-4.

With reference to the assembly described in FIG. 4, the configuration file FC1 of the “Camera” function comprises the following data:
/Camera -port=8080,
   where /Camera is the identifier of the source function, and -port=8080 is the identifier of the providing module on which the data processed by the sink function is made accessible.

The configuration file FC2 of the “Resize” function comprises the following data:
/Resize 192.168.0.1: 8080/cam -port=8080,
   where /Resize is the identifier of the first operation function, 192.168.0.1 is the network address of the compute node 11-1 on which the “Camera” function is instantiated and 8080/cam is the port/path pair of the compute node on which the “Camera” function is instantiated and on which the data processed by the “Camera” function is provided, and -port=8080 is the identifier of the providing module on which the data processed by the “Resize” function is made accessible.

The configuration file FC3 of the “YOLO” function comprises the following data:
/YOLO 192.168.5.1: 8080/rsz -port=8080,
   where /YOLO is the identifier of the second operation function, 192.168.5.1 is the network address of the compute node 11-2 on which the “Resize” function is instantiated and 8080/rsz is the port/path pair of the compute node on which the “Resize” function is instantiated and on which the data processed by the “Resize” function is provided, and -port=8080 is the identifier of the providing module on which the data processed by the “YOLO” function is made accessible.

The configuration file FC5 of the “Face” function comprises the following data:
/Face 192.168.5.1: 8080/rsz -port=8080,
   where /Face is the identifier of the second operation function, 192.168.5.1 is the network address of the compute node 11-2 on which the “Resize” function is instantiated and 8080/rsz is the port/path pair of the compute node on which the “Resize” function is instantiated and on which the data processed by the “Resize” function is provided, and -port=8080 is the identifier of the providing module on which the data processed by the “Face” function is made accessible.

Finally, the configuration file FC4 of the “Viz” function comprises the following data:
/Viz 192.168.10.1: 8080/objs,
/Viz 192.168.15.1: 8080/fcs
   where /Viz is the identifier of the second sink function, 192.168.10.1 is the network address of the compute node 11-3 on which the “YOLO” function is instantiated and 8080/objs is the port/path pair of the compute node on which the “YOLO” function is instantiated and on which the data processed by the “YOLO” function is provided, and 192.168.15.1 is the network address of the compute node 11-5 on which the “Face” function is instantiated, and 8080/fcs is the port/path pair of the compute node on which the “Face” function is instantiated and on which the data processed by the “Face” function is provided.

Once it has its configuration file FC, each elementary processing function FTE knows from which compute node to obtain the data it must process and on which providing module it must make its own data accessible.

The data comprised in these various configuration files FC is considered to be arguments of the elementary processing functions FTE that are provided to them as a preamble to their execution.

FIG. 5 shows the various steps implemented to process a multimedia stream by means of the processing application shown in FIG. 3 and obtained according to the method described with reference to FIG. 2.

In a step G1, a source function, here the “Camera” function, acquires images of a scene that it decodes during a step G2.

The “Camera” function also generates metadata relating to the decoded images. Such metadata is, for example, an identifier of the camera, a resolution of the latter, a timestamp of the captured images, a geolocation of the captured images, etc. Such metadata is comprised, for example, in the AAPn field (for “Application Specific”) or the COM field (for “Comment”) of the JPEG format (for “Joint Photographic Experts Group”) in which the images are encoded. Other still image processing formats and their corresponding data fields can of course be used, such as the PNG format with among others the iTXt, tEXt and zTXt fields, etc.

As indicated in the configuration file FC, the “Camera” function provides the decoded images and their metadata on the port 8080 of the compute node 11-1 on which the “Camera” function is instantiated in a step G3.

During a step G4, the “Resize” function obtains, in accordance with the information comprised in its configuration file FC1, the data provided by the “Camera” function.

Using the information comprised in the metadata accompanying the data obtained, the “Resize” function processes the latter in a step G5. The “Resize” function also generates metadata relating to the resized images, and this metadata still can comprise the information generated by the “Camera” function, such as the timestamp information, for example.

As indicated in the configuration file FC1, the “Resize” function provides the resized images and their metadata on port the 8080 of the compute node 11-2 on which the “Resize” function is instantiated in a step G6.

During a step G7, the “YOLO” function obtains, in accordance with the information comprised in its configuration file FC2, the data provided by the “Resize” function.

Using the information comprised in the metadata accompanying the data obtained, the “YOLO” function processes the latter during a step G8. The “YOLO” function also generates metadata relating to the objects identified in the resized images, and this metadata still can comprise the information generated by the “Camera” function and the “Resize” function, such as the timestamp information for example, as well as information relating to the identified objects such as their name, their position in the image, etc.

As indicated in the configuration file FC2, the “YOLO” function provides the resized images and their metadata on the port 8080 of the compute node 11-3 on which the “YOLO” function is instantiated in a step G9.

During a step G10, the “Viz” function obtains, in accordance with the information comprised in its configuration file FC, the data provided by the “YOLO” function.

Using the information comprised in the metadata accompanying the data obtained, the “Viz” function processes the latter in a step G11 and the images thus processed are thus displayed on a screen.

FIG. 6 shows a generation module 10 according to one embodiment of the development. A generation module 10 is able to implement the method for generating an application for processing a multimedia stream according to FIG. 2.

A generation module 10 may comprise at least one hardware processor 61, a storage unit 62, at least one interface 63, and at least one human-machine interface 64 which are connected to each other via a bus 65. Naturally, the elements constituting the generation module 10 can be connected by means of a connection other than a bus.

The processor 61 controls the operations of the generation module 10. The storage unit 62 stores at least one program for implementing the method according to one embodiment of the development to be executed by the processor 61, and various data, such as parameters used for calculations performed by the processor 61, intermediate data for calculations performed by the processor 61, etc. The processor 61 may be formed by any known and appropriate hardware or software, or by a combination of hardware and software. For example, the processor 61 can be formed by a dedicated hardware such as a processing circuit, or by a programmable processing unit such as a Central Processing Unit which executes a program stored in a memory thereof.

The storage unit 62 may be formed by any appropriate means capable of storing the program or programs and data in a computer-readable manner. Examples of storage devices 62 include non-transitory computer-readable storage media such as semiconductor memory devices, and magnetic, optical or magneto-optical recording media loaded into a read/write device.

The interface 63 provides a connection between the generation module 10 and all the compute nodes 11-i of the system.

The human-machine interface 64 can be a touch screen or a set comprising a keyboard, a mouse and a screen.

1. A method of generating an application for processing at least one multimedia stream, the processing application comprising an assembly of elementary processing functions, the method being implemented by an application generation module and comprising:
selecting elementary processing functions intended to be assembled to generate the processing application, an elementary processing function being instantiated on a compute node executing the elementary processing function, and
for a given selected elementary processing function, associating a configuration file comprising at least one parameter relating to at least a first elementary processing function generating data intended to be processed by the given elementary processing function.

2. The method of generating a processing application according to claim 1, wherein the parameter relating to the first elementary processing function comprises:
a network address of the compute node on which the first elementary processing function is instantiated,
a port of the compute node on which the first elementary processing function is instantiated, through which the data generated by the first elementary processing function is intended to be provided,
an identifier of the first elementary processing function.

3. The method of generating a processing application according to claim 2, wherein the parameter relating to the first elementary processing function is an argument of the given selected elementary processing function.

4. The method of generating a processing application according to claim 1, wherein the configuration file further comprises, for the given selected elementary processing function:
an identifier of at least one module for providing the data generated by the given selected elementary processing function.

5. The method of generating a processing application according to claim 4, wherein the identifier is an argument of the given selected elementary processing function.

6. The method of generating a processing application according to claim 4, wherein the module belongs to a group comprising:
a port of the compute node on which the given selected elementary processing function is instantiated,
a module for displaying the multimedia stream, and
a memory.

7. A method of processing at least one multimedia stream by a processing application comprising an assembly of elementary processing functions, an elementary processing function being instantiated on a compute node executing the elementary processing function, the method being implemented by a compute node and comprising:
obtaining data contained in the multimedia stream to be processed,
processing, by the elementary processing function instantiated on the node, the obtained data,
generating metadata associated with the processed data, and
providing the processed data and the generated metadata.

8. The method of processing at least one multimedia stream according to claim 7, wherein the data obtained is provided by at least one elementary processing function identified in a configuration file of the elementary processing function instantiated on the node.

9. The method of processing at least one multimedia stream according to claim 8, wherein the compute node obtains metadata associated with the obtained data, the metadata having also been generated by the elementary processing function identified in the configuration file of the elementary processing function instantiated on the node.

10. The method of processing at least one multimedia stream according to claim 7, wherein the data obtained is acquired by the compute node.

11. The method of processing at least one multimedia stream according to claim 7, wherein the metadata generated by the elementary processing function instantiated on the node belongs to a group comprising:
coordinates of a camera having acquired a content of the multimedia stream,
an identifier of the camera,
coordinates of at least one motion vector calculated for at least one image contained in the multimedia stream, and
at least one identifier of at least one object detected in at least one image contained in the multimedia stream.

12. The method of processing at least one multimedia stream according to claim 7, wherein the metadata is comprised in a data field of the at least one stream, relating to at least one still image to be processed.

13. A module for generating an application for processing at least one multimedia stream, the processing application comprising an assembly of elementary processing functions, the module for generating applications comprising means for:
selecting elementary processing functions intended to be assembled to generate the processing application, an elementary processing function being instantiated on a compute node executing the elementary processing function, and
for a given selected elementary processing function, associating a configuration file comprising at least one parameter relating to at least a first elementary processing function generating data intended to be processed by the given elementary processing function.

14. A compute node on which at least one elementary processing function comprised in an application for processing a multimedia stream is instantiated, the compute node executing the elementary processing function and comprising at least one processor configured to:
obtain data contained in the multimedia stream to be processed,
process, by means of the elementary processing function instantiated on the node, the obtained data,
generate metadata associated with the processed data, and
provide the processed data and the generated metadata.
